(19) United States
(12) Patent Application Publication
(10) Pub. No.: US 2026/0255211 A1
(43) Pub. Date: Aug. 27, 2026

(54) FLEXIBLE PACKET DELAY BUDGET CONFIGURATION FOR USER PLANE

(71) Applicant: INTERDIGITAL PATENT HOLDINGS, INC., Wilmington, DE (US)

(72) Inventors: Hyunsik YANG, Leonia, NJ (US); Francois PERIARD, Montreal (CA); Michael STARSINIC, Newtown, PA (US); Patrice HIRTZLIN, Betton (FR); Xavier DE FOY, Kirkland (CA); Loic FONTAINE, Noyal Sur Vilaine (FR); Mario HUDON, Brossard (CA); Rocco DI GIROLAMO, Laval (CA); Ulises OLVERA-HERNANDEZ, Saint-Lazare (CA); Saad AHMAD, Montreal (CA)

(21) Appl. No.: 19/061,295

(22) Filed: Feb. 24, 2025

(51) Int. Cl. H04W 28/02

(52) U.S. Cl. CPC H04W 28/0268

(57) ABSTRACT

Disclosed procedures, methods, architectures, apparatuses, systems, devices, and computer program products address limitations of conventional single-PDB (or more generally, single set of QoS requirements) approach in providing QoS. Disclosed solutions employ two or more QoS related parameter values and associated criteria for their selection, enabling more efficient data transmission and reception between a UE and the core network. The procedure can be initiated by either the network or the UE, utilizing various values as triggers for managing and adjusting current data traffic. For example, a RAN node can use criteria information such as the amount of buffered video on the UE to determine when to switch the 5QI value of a QoS Flow from a first value to a second value.

### BACKGROUND

The present disclosure is generally directed to the fields of communications, software and encoding, including, for example, to methods, architectures, apparatuses, systems related to Quality of Service (QOS) configuration in a communications system.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows an example procedure for flexible PDB based on a RAN calculation or estimate of how much data is buffered in the WTRU; and

FIG. 3 shows an example procedure for flexible PDB based on UE indications.

### DETAILED DESCRIPTION

In the following detailed description, numerous specific details are set forth to provide a thorough understanding of embodiments and/or examples disclosed herein. However, it will be understood that such embodiments and examples may be practiced without some or all the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

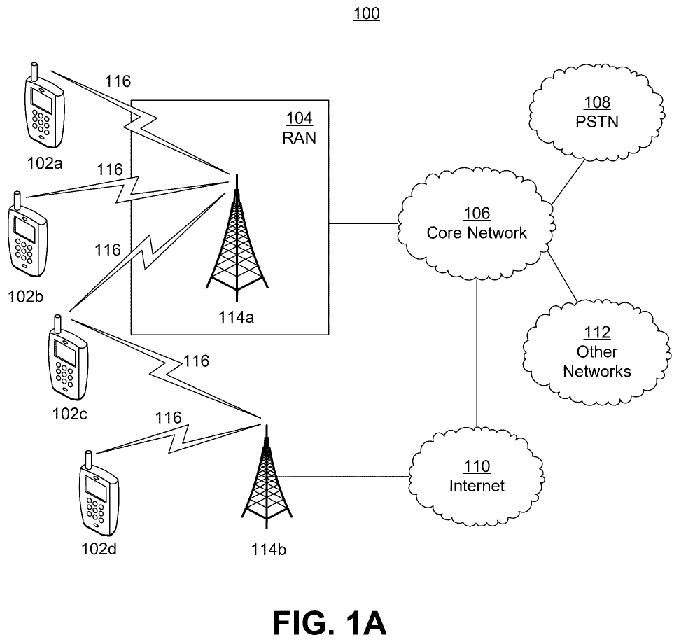

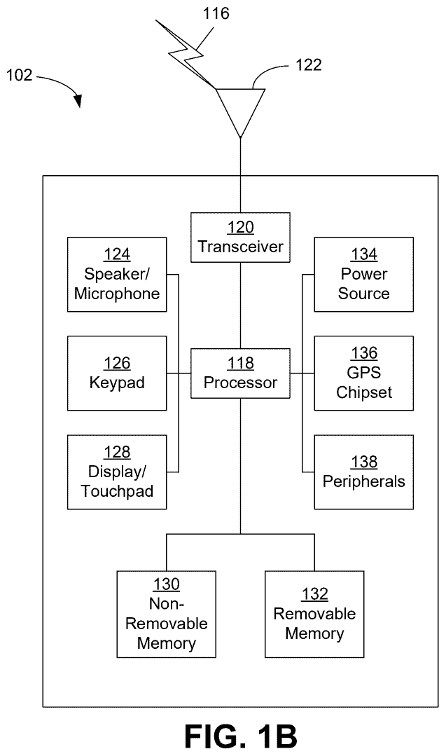

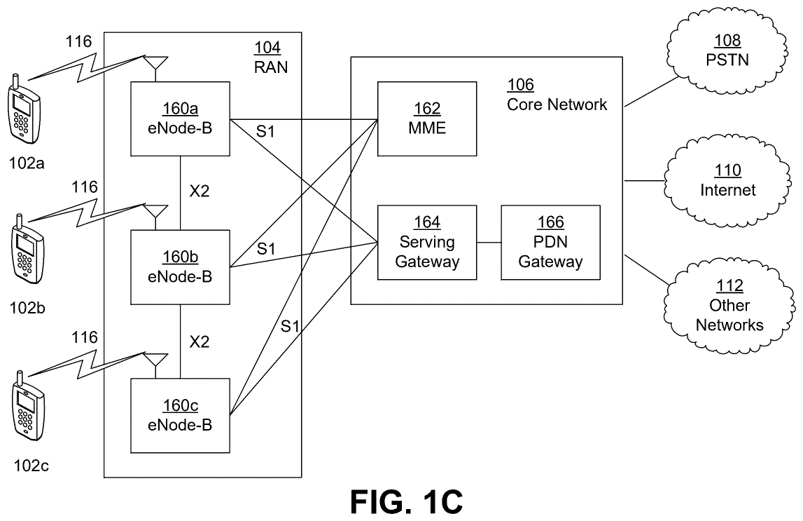

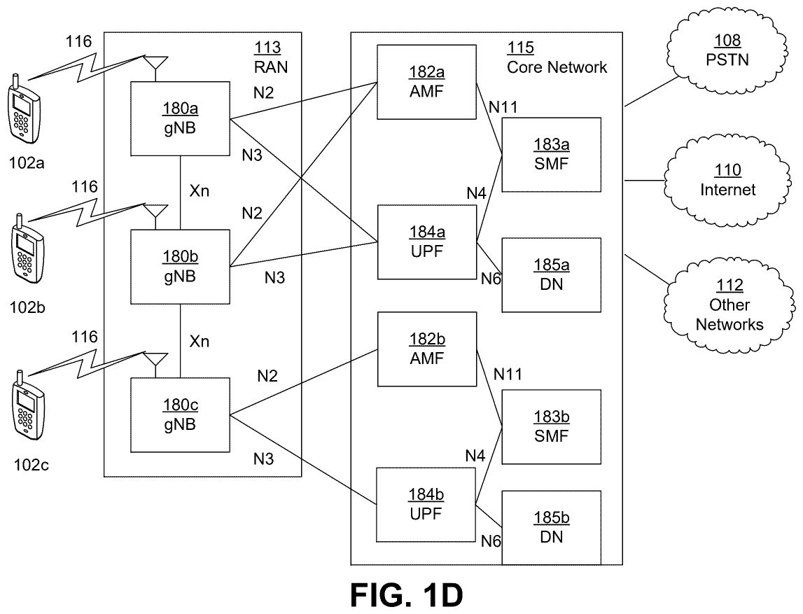

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80 +80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating a RAN 113 and a CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### ABBREVIATIONS AND ACRONYMS

5GS 5G System
5QI 5G QoS Identifier
AF Application Function
AS Application Server
AT Attention
GBR Guaranteed Bit Rate
GTP-U GPRS Tunnelling Protocol for User Plan
GPRS General Packet Radio Service
HARQ Hybrid Automatic Repeat Request
MT Mobile Termination
NAS Non-Access Stratum
NEF Network Exposure Function
PCC Policy and Charging Control
PCF Policy Control Function
PDB Packet Delay Budget
PDCP Packet Data Convergence Protocol
PDU Protocol Data Unit
QoE Quality of Experience
QoS Quality of Service
RAN Radio Access Network
RRC Radio Resource Control
SMF Session Management Function
TE Terminal Equipment
UE User Equipment
UPF User Plane Function
XR Extended Reality

### Notes on Terminology

Packet Delay Budget (PDB) in a 5G system refers to the maximum allowable delay for a packet of data to travel through the system from source to destination.

Criteria information refers to reference information used to evaluate specific conditions or scenarios as characterized by information referred to herein as condition information. Examples thereof include delay, and Quality of Experience (QoE), among others. QoE is a measure of the satisfaction of a user's experience when consuming a digital service, such as during an Extended Reality (XR) application, for example. Criteria information and condition information may be quantitative or qualitative.

A QoE metric is a metric quantifying a QoE. Several QoE metrics may quantify a QoE. For example, pose-to-render-to-photon and roundtrip interaction delay may quantify the QoE for an interactive XR application. Such a QoE metric being below a maximum threshold value may indicate that the user is experiencing an acceptable QoE. In other words, condition information (such as a QoE metric) obtained regarding a current QoE, may be compared to corresponding criteria information (such as a QoE threshold value), and based on said comparison, a determination can be made as to whether or not the current QoE is acceptable.

A QoE level is a level of representation and/or parameterization of an application content (e.g., XR scene, media) to be used in the context of QoE. When an application content has several QoE levels, this content is “flexible,” i.e., the content can be adapted (by selecting the appropriate QoE level) to maintain the QoE metric below the maximum threshold value. The selection of the appropriate QoE level may rely on the availability of QoE level thresholds (e.g., min, max values). In some cases, these QoE level thresholds are not known in advance (e.g., because they may depend on device-specific processing characteristics).

A QoE level threshold is a threshold value used to select the appropriate QoE level to maintain the QoE metric below the maximum threshold value.

The measurement of a QoE metric can be done at application level (i.e. by an application in either a WTRU or AS) as it includes processing tasks at application level (e.g., the rendering of the XR scene). Based on the measurement, the application running on the UE and/or AS may trigger an adaptation (i.e., a change of the QoE level) to maintain the QoE metric below the maximum threshold.

An application layer delay measurement may be an example of a QoE metric that is related to the network packet delay that is experienced by application layer traffic between a WTRU and an AS. A QoE level threshold may be associated with the application layer delay measurement QoE metric. Thus, the application layer delay measurement QoE metric measurement may be used to select one of two or more PDB values. For example, if the application layer delay measurement QoE metric measurement is below a QoE level threshold, then a first PDB value may be selected, and if the application layer delay measurement QoE metric measurement is above or equal to the QoE level threshold, then a second PDB value may be selected.

A UE may consist of an MT part and a TE part. The MT part may run the NAS and RRC layers of the protocol stack and control the sending and receiving of PDUs. The TE part of the UE may run applications. The TE and MT parts of the UE may communicate via an API (e.g., AT commands)

### Background

The 5G System (5GS) allows an Application Function (AF) of an Application Server (AS) to send QoS Requirements to the core network. The QoS Requirements can relate to a new or already established data flow. The QoS Requirements can include a Requested 5GS Delay value. The Requested 5GS Delay value (also referred to herein as 5GS Delay parameter) is a parameter that indicates the maximum amount of delay that can be experienced by traffic of the data flow when the traffic is sent through the 5GS. It can be assumed that if the traffic experiences more delay than the 5GS Delay parameter, then user experience will be negatively impacted. How the AF sends this information to the core network (i.e., directly to the PCF or to the PCF via the NEF) is described in clause 4.15.6.6 of 3GPP TS 23.502, Procedures for the 5G System (5GS); Stage 2; V 19.2.0 (hereinafter Document 1).

Reception of the QoS Requirements for a data flow may trigger the PCF to generate new PCC Rules for the PDU Session that carries the data flow. The new PCC Rules, which may be based on the QOS Requirements, may include one or more rules that describe the packet forwarding treatment that is required for the data flow. The PCF may send the PCC Rules to the SMF that serves the PDU Session. This procedure is described in clause 4.16.5.2 of Document 1. The PCC Rules that are sent to the SMF can include information as described in clause 6.3.1 of 3GPP TS 23.503, Policy and charging control framework for the 5G System (5GS); Stage 2; V 19.2.0 (hereinafter Document 2.) The information in a PCC Rule can include a Service data flow template and a 5G QOS Identifier (5QI) value. The 5QI value is described in clauses 5.7.2.1, 5.7.3.1, and 5.7.4 of 3GPP TS 23.501, System architecture for the 5G System (5GS); Stage 2; V 19.2.1 (hereinafter Document 3). 5QI values are values that map to 5G QoS characteristics, which describe the packet forwarding treatment that a QoS Flow receives. Included in these characteristics is Packet Delay Budget (PDB). Each 5QI value maps to, or is associated with, a single PDB value. The PCF may use the Requested 5GS Delay value to determine a PDB for the data flow. Thus, the PCF may use the Requested 5GS Delay value to determine the 5QI value to assign to the data flow. The PDB parameter is described in clause 5.7.3.4 of Document 3.

The 5G QoS characteristics to which the 5QI values map include: a resource type (i.e., GBR or non-GBR), a priority level, a PDB, a Packet Error Rate (PER), and a maximum data burst volume.

The SMF will use the PCC Rules received from the PCF to determine N4 Rules, QoS Profiles, and QoS Rules. The N4 Rules, QoS Profiles, and QoS Rules will be based on the SMF assigning the data flow to a QoS Flow. The SMF will then configure N4 Rules, QoS Profiles, and QoS Rules for the PDU Session. The N4 Rules are sent to the User Plane Function (UPF) that anchors the PDU Session. The QoS Profiles are sent to the RAN node that serves the UE. The QOS Rules are sent to the UE. This procedure is described in clause 4.3.3.2 of Document 1. That is, reception of the PCC Rules will trigger the SMF to initiate a PDU Session Modification procedure to reconfigure the PDU Session to give the data flow the QoS treatment that was requested by the AF.

### Problem Statement

The QoS framework in the 5G System is inflexible in the sense that only a single PDB value is associated with a QoS Flow. Dealing with downlink data, the RAN may receive a downlink PDU and will attempt to deliver the PDU to the UE within an amount of time that is based on the PDB. If the RAN cannot deliver the PDU within the amount of time, the RAN may consider the packet “lost” and may discard the PDU. Thus, the RAN uses the amount of time to determine what forwarding treatment to give the PDU. Forwarding treatment may refer to, e.g., the setting of scheduling priority weights and HARQ target operating points.

The inflexibility this QoS framework may be evident, for example, in a scenario in which the data flow carries a video stream to the UE. The UE may buffer PDUs of the video stream. If downlink PDUs are delayed more than a given time value, this might not cause a problem if the UE's video buffer is sufficiently full. If, however, the UE's video buffer is not sufficiently full, problems might arise if downlink PDUs are delayed more than a time value. An example of a problem that might arise is that the user experiences poor video quality because the buffer that is used to store video PDUs becomes empty.

Thus, the tolerable packet delay of a PDU may be dependent on how much data is buffered in the UE. The RAN, however, does not consider how much data may be buffered in the UE when determining the forwarding treatment that is required for the PDU. Instead, the RAN assumes, in the conventional QoS framework, that a single delay value must not be violated for all PDUs of a flow, regardless of the buffering capabilities of the UE and regardless of the state of the UE's buffer.

### Introduction

Solutions addressing one or more limitations of the conventional single-PDB approach in providing QoS are disclosed herein. One such solution leverages two PDB values and associated criteria for their selection, enabling more efficient data transmission and reception between the UE and the core network. A procedure in accordance with such a solution can be initiated by either the network or the UE, utilizing various values as triggers for managing and adjusting current data traffic.

This disclosure describes, among other things, how a RAN node can use criteria information and condition information to determine when to switch the 5QI value of a QoS Flow from a first value to a second value. The benefits of switching from a 5QI value that is associated with a first PDB to a 5QI value that is associated with a second PDB are described.

Benefits may also be gained by switching from a 5QI value that is associated with a first Packet Error Rate (PER) to a 5QI value that is associated with a second PER. For example, an increase in the amount of buffered data may result in a UE application being more tolerant of errors because a larger amount of buffered data may be associated with an improved ability of the UE to use Forward Error Correction (FEC) to correct errors in the data. For example, a decrease in the amount of buffered data may result in a UE application being less tolerant of errors because a smaller amount of buffered data may be associated with a decreased ability of the UE to use Forward Error Correction (FEC) to correct errors in the data.

However, benefits may also be gained by switching from a 5QI value that is associated with Guaranteed Bit Rate (GBR) resources to a 5QI value that is associated with non-GBR resources. For example, a change in the amount of buffered data may result in the UE application being more tolerant of errors because a large amount of buffered data may be associated with the UE having sufficient data to provide a good QoE and using non-dedicated resources for a time will not impact QoE.

### Proposed Solution 1: Flexible PDB Based on RAN Calculations

In example procedures described herein, the AF may provide the core network with a first set of QOS parameters including, e.g., a first Requested 5GS Delay value, and a second set of QoS parameters including, e.g., a second Requested 5GS Delay value. The second Requested 5GS Delay value may be greater than the first Requested 5GS Delay value. The AF may also provide the core network with criteria information. The criteria information may be used by the RAN to determine whether the first Requested 5GS Delay value or the second Requested 5GS Delay value should be the maximum delay for a PDU.

Procedures described herein use the 5GS Delay parameter (and the PDB derived from it) as an exemplary QoS parameter that can have one of two values applied based on criteria information. The procedures described herein can be extended to adjust the value of one or more QoS parameters including the Requested 5GS Delay and other QoS parameters, including, e.g., requested priority, maximum burst size, requested maximum bitrate, requested guaranteed bitrate, requested PER, requested PDU set delay, and/or requested PDU set error rate.

A first example of criteria information is information that can be used by the RAN to estimate whether the UE has sufficient data in the UE's buffer. For example, the criteria information can include a data size value, a first length of time, and a second length of time. The RAN may infer that the UE's buffer is sufficiently full if the RAN has delivered at least an amount of data equal to the data size value within the first length of time. The RAN may assume that the UE's buffer will stay sufficiently full for at least the second length of time. The first and second length of time values may be, for example, in units of seconds. The data size value may be, for example, in units of bits. Similar criteria may include an average bitrate (possibly with a time window to use as a basis for rate calculation), where the RAN may assume that the UE's buffer is sufficiently full if the data flow is delivered at or above the average bitrate.

A second example of criteria information is information that can be used by the RAN to estimate whether the current QoE is adequate. Here QoE refers to the QoE of the user of the UE. For instance, reference information may include quantitatively specified QoE levels for each service, as well as definitions for the minimum QoE level required to ensure service quality, and for the ideal QoE level. The current QoE of the user of the UE can be estimated based on an analysis of the current data transmission environment, which may include factors such as data playback speed and variations in data volume. The QoE can be estimated based on quantitative condition information, such as QoE metric measurements, that is received by the RAN, for example, in a Radio Resource Control (RRC) message, or from the Operations, Administration, and Maintenance (OAM) system. The QoE can be estimated based on analytics information that is received from an analytics network function such as the Network Data Analytics Function (NWDAF).

In an example, a first 5GS Delay value and a second 5GS Delay value may be provided to the network. The first 5GS Delay value may be larger than the second 5G Delay value. In other words, the first 5GS Delay value may be an amount of time that is more than the second 5GS Delay value. When the UE's buffer is assumed to be sufficiently full (i.e., because the criteria are met), the RAN may use the first 5GS Delay (i.e., larger delay value) value to determine how to prioritize delivery of the PDU to the UE. When the UE's buffer cannot be assumed to be sufficiently full (i.e., because the criteria are not met), the RAN may assume that the second 5GS Delay value (i.e., smaller delay value) should be used to determine how to prioritize delivery of the PDU to the UE. When the UE's buffer is sufficiently full, it may be advantageous to the network to use a larger delay value to prioritize delivery of the PDU to the UE because other traffic that is being sent to the network may require higher prioritization and the user experience that is associated with the other traffic may benefit from being prioritized. When the UE's buffer is sufficiently full, it may also be advantageous to the UE to use a larger delay value to prioritize delivery of the PDU to the UE because, if data is sent to the UE when UE's buffer is full, the UE Application may need to discard the data because there is no room in the buffer, discard some already buffered data to make room for the received data, or allocate more memory to the buffer. However, allocating more memory to the buffer may result in degrading other UE applications because less memory would be available in the UE for the other UE applications. In other words, sending data to the UE too quickly may result in the UE's buffer running out of room or the UE requiring a larger buffer.

Note that the criteria, or threshold, for switching from the first delay value to the second delay value may be different than the criteria for switching from the second delay value back to the first delay value. For example, the RAN may receive two sets of criteria information. The first set of criteria information may be used by the RAN to determine when to switch from the first to the second delay value and the second set of criteria information may be used by the RAN to determine when to switch from the second to the first delay value. Alternatively, the RAN may receive a single set of criteria information, and the RAN may apply hysteresis when switching between delay values.

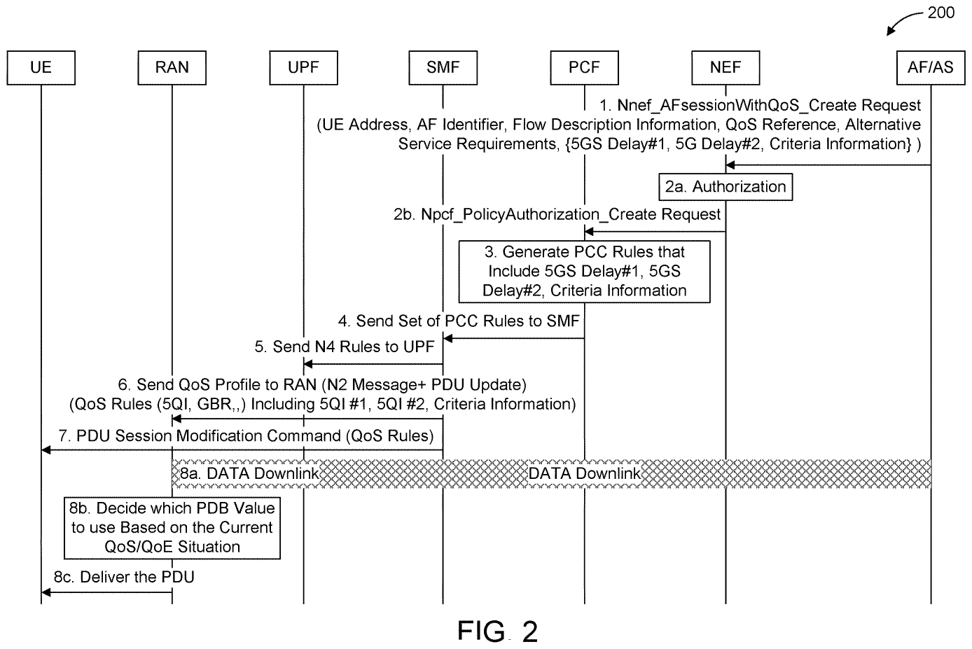

FIG. 2 illustrates an example procedure 200 for flexible PDB application based on RAN calculations. In procedure 200, the RAN configures parameters (e.g., the first 5GS Delay value and the second 5GS Delay value) assigned by the AF based on the current data transmission conditions of the UE. Unlike the conventional approach, the AF can define two 5GS Delay values, that can be selectively applied based on the UE's status.

As shown in FIG. 2, in step 1, the AF can define and send two 5GS Delay values and criteria to enable flexible PDB values application. In step 1, the AF sends a message to the Network Exposure Function (NEF) that includes at least a Flow Description information and two 5GS Delay values. The Flow Description information may include source and destination IP addresses and port numbers and protocol information and is used by the Policy Control Function (PCF) to enable the binding functionality and the generation or selection of the service data flow filter(s) in Policy and Charging Control (PCC) rules. This is further discussed in clause 6.1.3.6 of 3GPP TS 23.503, Policy and charging control framework for the 5G System (5GS); Stage 2; V19.2.0 (hereinafter Document 2).

The message sent in step 1 from the AF to the NEF may optionally include criteria information. Examples of criteria information are as follows.
1) A first example of criteria information is information that can be used by the RAN to estimate whether the UE has sufficient data in the UE's buffer. For example, the criteria information may include a data size value, a first length of time, and a second length of time. The RAN may assume that the UE's buffer is sufficiently full if the RAN has delivered at least an amount of data equal to the data size value within the first length of time. The RAN may assume that the UE's buffer will stay sufficiently full for at least the second length of time. The first and second length of time values may be, for example, in units of seconds. The data size value may be, for example, in units of bits.
2) A second example of criteria information is a QoE Threshold. The QoE threshold can be used by the network (i.e., the RAN) to determine what delay value should be applied to the flow. For example, if the measured or estimated QoE of the user is above the QoE Threshold, the larger delay value may be deemed sufficient. If the measured or estimated QoE of the user is below the QoE Threshold, the smaller delay value may be deemed necessary.
3) In a third example of criteria information, the AF may provide two sets of criteria information. The first set of criteria information may be used by the RAN to determine when to switch from the first 5GS Delay value to the second 5GS Delay value and the second set of criteria information may be used by the RAN to determine when to switch from the second 5GS Delay value to the first 5GS Delay value.

The AF may send the message of step 1 to the NEF using an NEF API request such as an Nnef_AFsession WithQoS_Create message.

In step 2a of procedure 200, the NEF authorizes the AF's request and in step 2b forwards the information from the AF request (e.g., the 5GS Delay values, the criteria information, and the Flow Description information) to the PCF that serves the PDU session that carries the flow (i.e., a previously established PDU Session). Note that the AF may provide the 5GS Delay values, the criteria information, and the Flow Description information directly to the PCF by invoking a PCF API request. The PCF API request that is invoked by the NEF or the AF in step 2b may be a Npcf_PolicyAuthorization_Create or Npcf_PolicyAuthorization_Update service operation. The parameters for such a service operation may include QoS parameters, such as the aforementioned 5GS Delay values and criteria information, and UE information. UE information may include the IP address (v4, v6) and MAC address of the UE. Invoking a service operation of a Network Function (NF) may refer to sending a request message to an NF. Invoking a service operation may refer to an NF sending a notification. An AF, AMF, PCF, SMF, and NEF are examples of NFs.

In step 3, the PCF determines Policy and Charging Control (PCC) rules based on the information provided by the AF via the NEF. The PCC rules can be configured using QoS parameters provided by the AF. The PCF can also define a policy for these rules. For example, regarding the two 5GS delay values, the PCC rules may specify the conditions under which each delay parameter is applied, allowing for flexible rule definitions. In other words, the PCC rules that relate to the Flow Description may include the two 5GS Delay values and the criteria information provided by the AF in step 1.

In step 4, the PCF sends the PCC rules to the Session Management Function (SMF). The SMF will assign the traffic that relates to the Flow Description information to a QoS Flow.

In step 5, the SMF sends N4 rules to the UPF. The SMF configures the N4 rules based on the PCC rules received from the PCF. This includes monitoring rules, flow-related information, buffer management, and link status information.

In step 6, the SMF sends and the RAN receives from the SMF a QoS Profile. The SMF configures the QoS Profile to include information that indicates that the QoS Flow which relates to the Flow Description information is associated with two sets of QoS requirements. For example, the QoS Profile may indicate that the QoS Flow is associated with two different 5QI values. The SMF may determine a first 5QI value based on the first 5GS Delay value and the SMF may determine a second 5QI value based on the second 5GS Delay value. The SMF may also configure the QoS Profile to include criteria information that can be used by the RAN to determine whether the first or second 5QI value should be associated with the QoS Flow; i.e., the criteria information may be used by the RAN to determine which 5QI value describes the requirements for each PDU of the flow.

In step 7, the SMF determines one or more QoS Rules for the PDU Session which carries the traffic that relates to the Flow Description information. The SMF transmits the QoS Rule(s) to the UE in a PDU Session Modification Command.

At step 8a, the RAN node serving the UE receives downlink traffic which maps to the QoS Flow that relates to the Flow Description information provided by the AF/AS in step 1.

At step 8b, based on the QoS Profile that was received from the SMF in step 6, the RAN determines that the QoS Flow is associated with two 5QI values and the criteria information. The RAN node uses the criteria information to determine which of the 5QI values should be applied to the PDU and uses the determined 5QI value to determine the forwarding treatment for the QoS Flow. It should be noted that the order of steps 8a and 8b can be reversed; i.e., the RAN can determine how to treat the downlink traffic before receiving it.

As discussed above, the criteria information may include a data size value, a first length of time, and a second length of time. The RAN node may measure how much data of the QoS Flow is sent to the UE and may infer that the UE's buffer is sufficiently full if the RAN node has delivered at least an amount of data equal to the data size value within the first length of time. If so, the RAN node may assume that the UE's buffer will stay sufficiently full for at least the second length of time. When the RAN node determines that the UE's buffer is sufficiently full, the RAN node may assume that the second 5QI value should be used to determine the treatment that is required by the traffic of the QoS Flow and treat the traffic accordingly. If, however, the RAN node determines that the UE's buffer is not sufficiently full, the RAN node may assume that the first 5QI value should be used to determine the treatment that is required by the traffic of the QoS Flow and treat the traffic accordingly. The first 5QI value may be associated with a larger PDB than the second 5QI value.

As also discussed above, the criteria information may include a QoE threshold value. The RAN node may receive, from one or more sources, QoE condition information indicative of the QoE associated with the QoS Flow or the Flow Description information (received at step 6 from the SMF in the QoS Profile). For example, the RAN node may receive QoE information from the UE in an RRC message or from the OAM System. The RAN node may send a subscription request to a Network Function (NF) such as the NWDAF to indicate that the RAN node wants to receive notifications about the QoE that is associated with the QoS Flow or the Flow Description information. The subscription request may indicate that the RAN node wants to be notified when the QoE passes a threshold value such as the QoE threshold value indicated in the criteria information. When the RAN node determines that the QoE associated with the QoS Flow is higher than the QoE value in the criteria information, the RAN node may assume that the first 5QI value (associated with a larger PDB) should be used to determine the treatment that is required by the traffic of the QoS Flow and treat the traffic accordingly. When the RAN determines that the QoE associated with the QoS Flow is lower than the QoE value in the criteria information, the RAN may assume that the second 5QI value (associated with a smaller PDB) should be used to determine the treatment that is required by the traffic of the QoS Flow and treat the traffic accordingly.

The criteria information may indicate that the selection of a 5QI value should be based on an indication in a General Packet Radio Service (GPRS) Tunneling Protocol-User Plane (GTP-U) header. The RAN node may determine which 5QI value to apply based on an indication that is received from the UPF in a GTP-U header, or an indication that is received from the UE in a Packet Data Convergence Protocol (PDCP) header; or based on inspecting uplink data from the UE Application; or based on inspecting downlink data from the AF/AS. For example, the indication in the GTP-U header, which is provide by the UPF, may indicate a preference for a larger delay value or a smaller delay value. The UPF may determine what preference to indicate based on information that is detected in the header of a downlink PDU. For example, the UPF may determine what preference to indicate based on a field in an application protocol header. Real-Time Protocol (RTP) is an example of an application protocol. For example, the application server (AS) may determine, based on application layer messaging that is received from the UE, that the UE's buffer is sufficiently fully or not sufficiently full. The AS may then use this determination to decide whether to indicate a preference for a larger delay value or a smaller delay value in the application protocol header of downlink traffic (i.e., downlink PDUs).

In step 8b of procedure 200, the RAN node may use the criteria information and condition information to determine whether to attempt to deliver the PDU in less than a first delay time or in less than a second delay time. The first delay time may be associated with a first 5QI value and the second delay time may be associated with a second 5QI value. Whether the first delay time or the second delay time is used to determine how to prioritize delivery of the PDU may be based on the selected 5QI value. The condition information may include one or more measurements such as a measurement of how much data was recently delivered to the UE and/or a measurement of QoE. In example procedure 200, the RAN node may initially assume that the UE's buffer is not sufficiently full. In other words, when the RAN node receives the first downlink packet of the flow, the UE may initially assume that the UE's buffer is not sufficiently full. For example, when the RAN node receives the first downlink packet, the UE may be in an RRC Idle state and delivery of the first packet causes the UE to transition to an RRC Connected state. The RAN node may assume that the UE's buffer is not sufficiently full when the UE is in an RRC Idle state.

Thus, in step 8b, the RAN uses the first delay time or the second delay time (i.e. whichever delay time the RAN node selected based on the criteria and the condition information) to determine what forwarding treatment to give the PDU. Forwarding treatment may refer to, for example, the setting of scheduling priority weights and HARQ target operating points.

Based on the forwarding treatment determined in step 8b, the RAN node transmits the PDU to the UE at step 8c.

### Proposed Solution 2: Flexible PDB Based on UE Indications

The example procedure 200 of FIG. 2 shows how the RAN may determine a delay limitation based on how much data is stored in the UE's application layer buffer without direct knowledge of how much data is stored in the UE's application layer buffer. One or more solutions are contemplated herein in which the RAN may determine a delay limitation based on information that is received by the RAN and is directly indicative of how much data is stored in the UE's buffer.

In a new procedure designated herein as “UE-assisted” flexible PDB, using Service Data Adaptation Protocol (SDAP) the UE can provide feedback, including its QoS requirements, based on its current buffer status. To activate this functionality, the QoS profile and QoS rules may include indicators to trigger the UE-assisted feature. Thus, an indication in the QoS Profile that is sent by the SMF to the RAN may include an indication to activate the UE-assisted feature. An indication in the QoS Rules that are sent to the UE may include an indication to activate the UE-assisted feature.

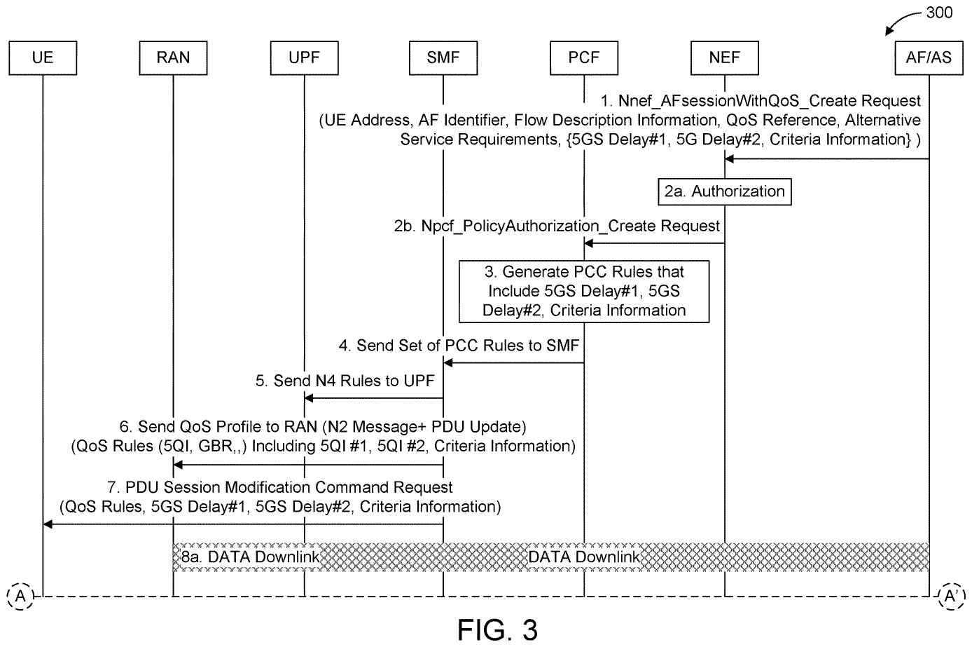

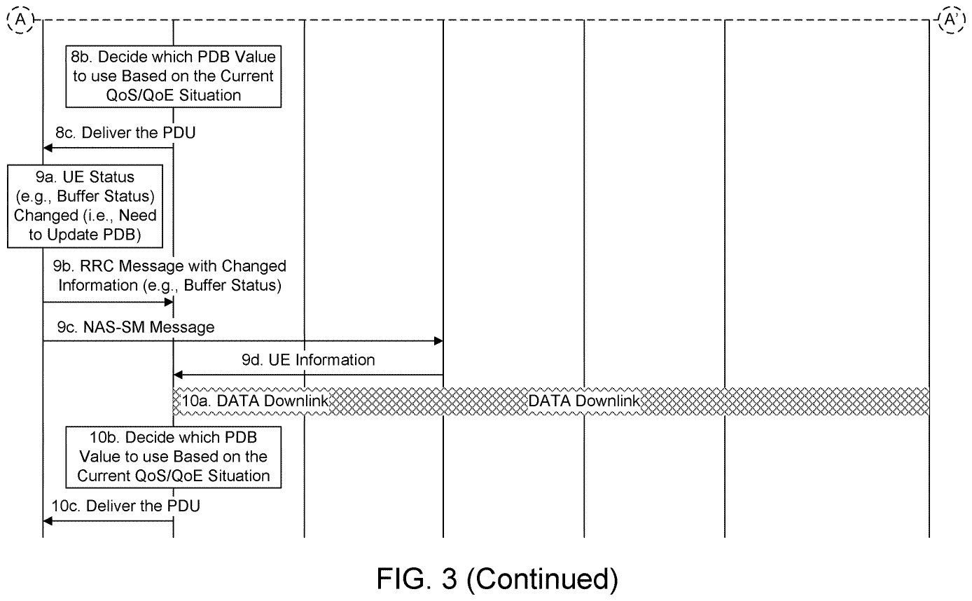

FIG. 3 illustrates such an example procedure 300.

In example procedure 300, in which the UE-assisted feature is activated, if the UE's buffer does not contain a sufficient amount of data, the UE can request the RAN to use delay values or 5QI values that will result in a relatively smaller delay. If the UE's buffer does contain a sufficient amount of data, the UE can indicate to the RAN that the RAN may use delay values or 5QI values that will result in a relatively larger delay. An indication that may be sent from the UE is described in greater detail below with respect to step 7 of example procedure 300. To achieve this, configuration values for feature activation and the types of data used for monitoring can be defined.

In another example involving QoS parameters other than PDB, in a case where the UE application observes a high QoE and/or a low number of lost packets, the UE may send an indication to the RAN to enable the RAN to apply a higher packet loss ratio. In a case where the UE application observes a low QoE and/or a high number of lost packets, the UE may send an indication to the RAN to request applying a lower packet error rate. In yet another example involving QoS parameters other than PDB, the UE may send an indication requesting the application of a set of (higher or lower) QoS parameters, depending on the media buffering usage or estimated QoE.

In example procedure 300 shown in FIG. 3, the UE triggers parameter modification with 5GS delay values and criteria based on the status of the UE. Unlike the conventional single-PDB approach, the AF can define two 5GS values that can be selectively applied based on the UE's current status, as may be provided in one or more indications from the UE.

Step 1 of procedure 300 may include the same actions as step 1 of procedure 200 of FIG. 2. However, in step 1 of procedure 300, the criteria information may also indicate that the decision to use the first 5GS delay value or the second 5GS delay value may be based on:
1) information that is received from the UE,
2) information that is received from the AS, or
3) information that is detected in the UPF, or
4) information that is detected in the user plane signaling from the UE or AS.

Step 2a may include the same actions as step 2a of procedure 200. However, the message sent by the NEF in step 2b of procedure 300 may also include the aforementioned criteria information of step 1, which indicates that the first 5GS Delay value or the second 5GS Delay value may be based on:
1) information that is received from the UE,
2) information that is received from the AS, or
3) information that is detected in the UPF, or
4) information that is detected in the user plane signaling from the UE or AS.

Step 3 may include the same actions as step 3 of procedure 200. The PCC Rules determined by the PCF, however, may indicate that the 5GS delay value may be based on:
1) information that is received from the UE,
2) information that is received from the AS, or
3) information that is detected in the UPF, or
4) information that is detected in the user plane signaling from the UE or AS.

Step 4 may include the same actions as step 4 of procedure 200.

Step 5 may include the same actions as step 5 of procedure 200.

Step 6 may be the same as step 6 of procedure 200. In step 6 of procedure 300, however, the criteria information may indicate to the RAN that the 5QI value that is to apply to a PDU may be based on:
1) information that is received from the UE,
2) information that is received from the AS, or
3) information that is detected in the UPF, or
4) information that is detected in the user plane signaling from the UE or AS.

In step 7, the SMF sends a PDU Session Modification Command to the UE. As shown in FIG. 3, in addition to the inclusion of the QoS Rule(s), the PDU Session Modification Command may be enhanced to include first and second delay values (e.g., 5GS Delay #1, 5GS Delay #2) and criteria information. As an alternative to sending first and second delay values to the UE in this step, the network may send first and second 5QI values and each 5QI value may be associated with a different delay value. The inclusion of this additional information in the PDU Session Modification Command can thus act as an indication to the UE that the UE should transmit condition information that is indicative of the state of the UE's buffer. The information that is indicative of the state of the UE's buffer may include:
1) a binary indication that indicates that the buffer is sufficiently full or not sufficiently full,
2) an extent, e.g., percentage, of buffer fullness, or
3) a size value that indicates how much space is available for data in the buffer, or
4) an indication of a preference to use a higher or lower delay value, or
5) QoE condition information.

QoE information may be considered information that is indicative of the state of the UE's buffer because a buffer that is not sufficiently full may cause low QoE measurements, whereas a buffer that is sufficiently full may cause higher QoS measurements.

Steps 8a, 8b, and 8c of procedure 300 may include the same actions as steps 8a, 8b, and 8c of procedure 200. In procedure 300, the RAN node may initially assume that the UE's buffer is not sufficiently full.

In steps 9a and 9b of procedure 300, the UE generates and sends a notification to the RAN node to request to change the 5GS Delay value based on the current state of the UE. The notification may be included in an RRC message. The UE may use the information that was received in step 7 to determine whether it should send the notification to the RAN node. For example, if the condition information in step 7 indicated that the information that is indicative of the state of the UE's buffer may include an indication of a preference to use a higher or lower delay value, then the UE may use the notification to the RAN node to indicate a preference for the first delay value or the second delay value. For example, if the condition information in step 7 indicated that the information that is indicative of the state of the UE's buffer may include a binary indication that indicates that the buffer is sufficiently full or not sufficiently full, an extent of buffer fullness, or a size value that indicates how much space is available for data in the buffer, then the UE may determine to monitor how much data is stored in the buffer and trigger the notification to the RAN node based on how much data is stored in the buffer. For example, the UE may request that the RAN node use the smaller delay value when the UE's buffer is not sufficiently full and the UE may request that the RAN node use the larger delay value when the UE's buffer is sufficiently full. For example, if the condition information in step 7 indicated that the information that is indicative of the state of the UE's buffer may include QoE condition information, then the UE may receive a QoE measurement from a UE Application and may use the measurement to determine whether to indicate a preference for the first delay value or the second delay value. For example, the UE may determine to indicate a preference for the smaller delay value when the QoE measurement is equal to or below a threshold and the UE may determine to indicate a preference for the larger delay value when the QoE measurement is above the threshold.

In Step 9a, a UE Application may invoke an API or AT Command to notify the Mobile Termination (MT) part of the UE that: the UE Application buffer is currently sufficiently full or not sufficiently full; and/or a QoE measurement that is associated with the UE Application is sufficiently high or is not sufficiently high.

Based on the information that is received from the UE Application, the Non-Access Stratum (NAS) layer of the UE may send information to the RRC Layer of the UE. The information that is sent to the RRC Layer may be indicative of whether a lower PDB is preferred or whether a higher PDB can be tolerated. This information may trigger the RRC layer of the UE to send a notification to the RAN in step 9b. The notification may include information indicative of the state of the UE's buffer, as described above with respect to step 7.

The notification sent by the UE to the network in step 9b may be sent in an RRC message to the RAN. Alternatively, in step 9c, the notification may be sent by the UE to the network in a Non-Access Stratum-Session Management (NAS-MS) message to the SMF. The notification, or the relevant information therein, may then be sent in step 9d from the SMF to the RAN node.

In step 10a, the RAN receives downlink traffic that maps to the QoS Flow which relates to the flow description.

At step 10b, based on the QoS Profile that was received in step 6, the RAN determines that the QoS Flow is associated with two 5QI values and criteria information. Based on the notification that was received from the UE in step 9b (or from the SMF in step 9d) and the criteria information that was received in step 6, the RAN node determines which 5QI value to apply to the downlink traffic and uses the determined 5QI value to determine the forwarding treatment for the QoS Flow. For example, the RAN node may be configured with information that indicates a delay value, priority value, and PER value associated with each 5QI value. The priority value indicates the priority of the traffic that is associated with the 5QI value relative to the priority of traffic that is associated with other 5QI values. The RAN node may select a 5QI value based on whether or not the RAN node has determined that the UE's Application Data buffer is sufficiently full. For example, the RAN node may select a 5QI value that is associated with a smaller delay value and/or smaller PER value if the RAN node determines that the UE's Application Data buffer is not sufficiently full and the RAN node may select a 5QI value that is associated with a larger delay value and/or a larger PER value if the RAN node determines that the UE's Application Data buffer is sufficiently full. The RAN node may then schedule the traffic for transmission to the UE. The scheduling priority may be based on the priority that is associated with the 5QI value. The HARQ target operating point may be based on the PER that is associated with the 5QI value.

Alternatively, the RAN node may may determine which 5QI value to apply based on an indication that is received from the UPF in a GTP-U header, or on an indication that is received from the UE in a PDCP header; or based on inspecting uplink data from the UE Application, or on inspecting downlink data from the AS.

Thus, in step 10b, the RAN uses the determined 5QI value to determine what forwarding treatment to give the PDU and at step 10c sends the second downlink PDU to the UE based on the determined forwarding treatment. The forwarding treatment is determined by the RAN based on the indication that was received from the UE in step 9b and may be different than the forwarding treatment used in step 8c.

It should be noted that as with steps 8a and 8b, the order of steps 10a and 10b can be reversed; i.e., the RAN can determine how to treat the downlink traffic before receiving it.

Procedure 300 of FIG. 3 represents an enhancement of procedure 200 in that procedure 300 entails the RAN node receiving status or preference information directly from the UE. Advantageously, procedure 200 does not require the UE to send status or preference information. Procedure 200, however, requires that the RAN node determine if the UE Application can tolerate a higher PDB. In procedure 200, the RAN node would make this determination without receiving status, or preference information directly from the UE.

In the example procedures 200 and 300, the network selects one of two PDB values based on criteria information. As contemplated herein, the network may select one of N PDB values based on criteria information, where N≥2.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed,” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Examples, without limitation, of embodiments as contemplated by the present disclosure are set forth in the following clauses.

Clause 1: a method performed by a network element hosting a radio access network (RAN) function, the method comprising: receiving, from a network element hosting a core network function (NF) at least two quality related parameter values and criteria information, the criteria information including information for selecting one of the at least two quality related parameter values in accordance with which a Protocol Data Unit (PDU) is treated; obtaining condition information associated with the criteria information; selecting one of the at least two quality related parameter values in accordance with the criteria information and the condition information; receiving the PDU; and sending the PDU to a wireless transmit/receive unit (WTRU), wherein the condition information includes: data delivery information, quality of experience (QoE) information, General Packet Radio Service Tunnelling Protocol for User Plane (GTP-U) header information, or information from the WTRU.

Clause 2: the method of clause 1 comprising receiving the information from the WTRU.

Clause 3: the method of clause 1 or 2, wherein the data delivery information includes at least one of a size, a length of time, or a rate of a data delivery to the WTRU.

Clause 4: the method of clause 1, 2, or 3, wherein the information from the WTRU includes information indicative of a state of a data buffer of the WTRU.

Clause 5: the method of clause 1, 2, 3, or 4, wherein each of the at least two quality related parameters includes at least one of a 5G QoS Identifier (5QI), a 5G System (5GS) Delay value, or a Packet Delay Budget (PDB) value.

Clause 6: the method of clause 1, 2, 3, 5, or 5, wherein the PDU is sent in accordance with the selected quality related parameter.

Clause 7: a network element hosting a radio access network (RAN) function, the network element comprising one or more processors configured to: receive, from a network element hosting a core network function (NF) at least two quality related parameter values and criteria information, the criteria information including information for selecting one of the at least two quality related parameter values in accordance with which a Protocol Data Unit (PDU) is treated; obtain condition information associated with the criteria information; select one of the at least two quality related parameter values in accordance with the criteria information and the condition information; receive the PDU; and send the PDU to a wireless transmit/receive unit (WTRU), wherein the condition information includes: data delivery information, quality of experience (QoE) information, General Packet Radio Service Tunnelling Protocol for User Plane (GTP-U) header information, or information from the WTRU.

Clause 8: the network element of clause 7, configured to receive the information from the WTRU.

Clause 9: the network element of clause 7 or 8, wherein the data delivery information includes at least one of a size, a length of time, or a rate of a data delivery to the WTRU.

Clause 10: the network element of clause 7, 8, or 9, wherein the information from the WTRU includes information indicative of a state of a data buffer of the WTRU.

Clause 11: the network element of clause 7, 8, 9, or 10, wherein each of the at least two quality related parameters includes at least one of a 5G QoS Identifier (5QI), a 5G System (5GS) Delay value, or a Packet Delay Budget (PDB) value.

Clause 12: the network element of clause 7, 8, 9, 10, or 11, wherein the PDU is sent in accordance with the selected quality related parameter.

Clause 13: a method performed by a wireless transmit/receive unit (WTRU), the method comprising: receiving a message relating to a quality of service (QOS) of a Protocol Data Unit (PDU); and receiving the PDU from a Radio Access Network (RAN), wherein the PDU is treated in accordance with a quality related parameter value selected from a set of at least two quality related parameter values in accordance with criteria information and condition information, the condition information including at least one of: data delivery information, quality of experience (QoE) information, General Packet Radio Service Tunnelling Protocol for User Plane (GTP-U) header information, or information from the WTRU, wherein the information from the WTRU includes at least one of an information indicative of a state of a data buffer of the WTRU, or information indicative of a preference of a packet delay.

Clause 14: the method of clause 13, wherein: the message includes an indication to send the information from the WTRU, and the method comprises sending the information from the WTRU to the RAN.

Clause 15: the method of clause 13 or 14, wherein the data delivery information includes at least one of a size, a length of time, or a rate of a data delivery to the WTRU.

Clause 16: the method of clause 13, 14, or 15 comprising: sending the information from the WTRU based on a request from a User Equipment (UE) application.

Clause 17: the method of clause 13, 14, 15, or 16, wherein each of the at least two quality related parameter values includes at least one of a 5G QoS Identifier (5QI), a 5G System (5GS) Delay value, or a Packet Delay Budget (PDB) value.

Clause 18: a wireless transmit/receive unit (WTRU) comprising a transceiver and one or more processors configured to: receive a message relating to a quality of service (QOS) of a Protocol Data Unit (PDU); and receive the PDU from a Radio Access Network (RAN), wherein the PDU is treated in accordance with a quality related parameter value selected from a set of at least two quality related parameter values in accordance with criteria information and condition information, the condition information including at least one of: data delivery information, quality of experience (QoE) information, General Packet Radio Service Tunnelling Protocol for User Plane (GTP-U) header information, or information from the WTRU, wherein the information from the WTRU includes at least one of an information indicative of a state of a data buffer of the WTRU, or information indicative of a preference of a packet delay.

Clause 19: the WTRU of clause 18, wherein: the message includes an indication to send the information from the WTRU, and the method comprises sending the information from the WTRU to the RAN.

Clause 20: the WTRI of clause 18 or 19, wherein the data delivery information includes at least one of a size, a length of time, or a rate of a data delivery to the WTRU.

Clause 21: the WTRU of clause 18, 19, or 20, configured to send the information from the WTRU based on a request from a User Equipment (UE) application.

Clause 22: the WTRU of clause 18, 19, 20, or 21, wherein each of the at least two quality related parameter values includes at least one of a 5G QoS Identifier (5QI), a 5G System (5GS) Delay value, or a Packet Delay Budget (PDB) value.

Clause 23: a method performed by a network element hosting a core network function (NF), the method comprising: obtaining at least two quality related parameter values and criteria information; and sending to a further network element hosting a further NF: the at least two quality related parameter values or at least two further parameter values associated with the at least two quality related parameter values, and the criteria information, wherein the criteria information includes information for selecting one of the at least two quality related parameter values or one of the at least two further parameter values in accordance with which a Protocol Data Unit (PDU) is treated.

Clause 24: the method of clause 23, wherein the further NF is a core network function or a radio access network (RAN) function.

Clause 25: the method of clause 23 or 24, wherein the NF is at least one of a Network Exposure Function (NEF), a Policy Control Function (PCF), or a Session Management Function (SMF).

Clause 26: the method of clause 23, 24, or 25, wherein the criteria information is associated with: data delivery information, quality of experience (QoE) information, General Packet Radio Service Tunnelling Protocol for User Plane (GTP-U) header information, or information from a wireless transmit/receive unit (WTRU).

Clause 27: the method of clause 23, 24, 25, or 26, wherein each of the at least two quality related parameter values includes at least one of a 5G System (5GS) Delay value, or a Packet Delay Budget (PDB) value and wherein each of the at least two further parameter values includes at least one of a 5G QoS Identifier (5QI) or a Packet Delay Budget (PDB) value.

Clause 28: a network element hosting a core network function (NF), the network element comprising one or more processors configured to: obtain at least two quality related parameter values and criteria information; and send to a further network element hosting a further NF: the at least two quality related parameter values or at least two further parameter values associated with the at least two quality related parameter values, and the criteria information, wherein the criteria information includes information for selecting one of the at least two quality related parameter values or one of the at least two further parameter values in accordance with which a Protocol Data Unit (PDU) is treated.

Clause 29: the network element of clause 28, wherein the further NF is a core network function or a radio access network (RAN) function.

Clause 30: the network element of clause 28 or 29, wherein the NF is at least one of a Network Exposure Function (NEF), a Policy Control Function (PCF), or a Session Management Function (SMF).

Clause 31: the network element of clause 28, 29, or 30, wherein the criteria information is associated with: data delivery information, quality of experience (QoE) information, General Packet Radio Service Tunnelling Protocol for User Plane (GTP-U) header information, or information from a wireless transmit/receive unit (WTRU).

Clause 32: the network element of clause 28, 29, 30, or 31, wherein each of the at least two quality related parameter values includes at least one of a 5G System (5GS) Delay value, or a Packet Delay Budget (PDB) value and wherein each of the at least two further parameter values includes at least one of a 5G QoS Identifier (5QI) or a Packet Delay Budget (PDB) value.

1. A method performed by a network element hosting a radio access network (RAN) function, the method comprising:
receiving, from a network element hosting a core network function (NF) at least two quality related parameter values and criteria information, the criteria information including information for selecting one of the at least two quality related parameter values in accordance with which a Protocol Data Unit (PDU) is treated;
obtaining condition information associated with the criteria information;
selecting one of the at least two quality related parameter values in accordance with the criteria information and the condition information;
receiving the PDU; and
sending the PDU to a wireless transmit/receive unit (WTRU),
wherein the condition information includes:
data delivery information,
quality of experience (QoE) information,
General Packet Radio Service Tunnelling Protocol for User Plane (GTP-U) header information, or
information from the WTRU.

2. The method of claim 1 comprising receiving the information from the WTRU.

3. The method of claim 1, wherein the data delivery information includes at least one of a size, a length of time, or a rate of a data delivery to the WTRU.

4. The method of claim 1, wherein the information from the WTRU includes information indicative of a state of a data buffer of the WTRU.

5. The method of claim 1, wherein each of the at least two quality related parameters includes at least one of a 5G QoS Identifier (5QI), a 5G System (5GS) Delay value, or a Packet Delay Budget (PDB) value.

6. The method of claim 1, wherein the PDU is sent in accordance with the selected quality related parameter.

7. A network element hosting a radio access network (RAN) function, the network element comprising one or more processors configured to:
receive, from a network element hosting a core network function (NF) at least two quality related parameter values and criteria information, the criteria information including information for selecting one of the at least two quality related parameter values in accordance with which a Protocol Data Unit (PDU) is treated;
obtain condition information associated with the criteria information;
select one of the at least two quality related parameter values in accordance with the criteria information and the condition information;
receive the PDU; and
send the PDU to a wireless transmit/receive unit (WTRU),
wherein the condition information includes:
data delivery information,
quality of experience (QoE) information,
General Packet Radio Service Tunnelling Protocol for User Plane (GTP-U) header information, or
information from the WTRU.

8. The network element of claim 7, configured to receive the information from the WTRU.

9. The network element of claim 7, wherein the data delivery information includes at least one of a size, a length of time, or a rate of a data delivery to the WTRU.

10. The network element of claim 7, wherein the information from the WTRU includes information indicative of a state of a data buffer of the WTRU.

11. The network element of claim 7, wherein each of the at least two quality related parameters includes at least one of a 5G QoS Identifier (5QI), a 5G System (5GS) Delay value, or a Packet Delay Budget (PDB) value.

12. The network element of claim 7, wherein the PDU is sent in accordance with the selected quality related parameter.

13. A method performed by a wireless transmit/receive unit (WTRU), the method comprising:
receiving a message relating to a quality of service (QOS) of a Protocol Data Unit (PDU); and
receiving the PDU from a Radio Access Network (RAN),
wherein the PDU is treated in accordance with a quality related parameter value selected from a set of at least two quality related parameter values in accordance with criteria information and condition information, the condition information including at least one of:
data delivery information,
quality of experience (QoE) information,
General Packet Radio Service Tunnelling Protocol for User Plane (GTP-U) header information, or
information from the WTRU,
wherein the information from the WTRU includes at least one of an information indicative of a state of a data buffer of the WTRU, or information indicative of a preference of a packet delay.

14. The method of claim 13, wherein:
the message includes an indication to send the information from the WTRU, and
the method comprises sending the information from the WTRU to the RAN.

15. The method of claim 13, wherein the data delivery information includes at least one of a size, a length of time, or a rate of a data delivery to the WTRU.

16. The method of claim 13, comprising:
sending the information from the WTRU based on a request from a User Equipment (UE) application.

17. The method of claim 13, wherein each of the at least two quality related parameter values includes at least one of a 5G QoS Identifier (5QI), a 5G System (5GS) Delay value, or a Packet Delay Budget (PDB) value.

18. A wireless transmit/receive unit (WTRU) comprising a transceiver and one or more processors configured to:
receive a message relating to a quality of service (QOS) of a Protocol Data Unit (PDU); and
receive the PDU from a Radio Access Network (RAN),
wherein the PDU is treated in accordance with a quality related parameter value selected from a set of at least two quality related parameter values in accordance with criteria information and condition information, the condition information including at least one of:
data delivery information,
quality of experience (QoE) information,
General Packet Radio Service Tunnelling Protocol for User Plane (GTP-U) header information, or
information from the WTRU,
wherein the information from the WTRU includes at least one of an information indicative of a state of a data buffer of the WTRU, or information indicative of a preference of a packet delay.

19. The WTRU of claim 18, wherein:
the message includes an indication to send the information from the WTRU, and the method comprises sending the information from the WTRU to the RAN.

20. The WTRI of claim 18, wherein the data delivery information includes at least one of a size, a length of time, or a rate of a data delivery to the WTRU.

21. The WTRU of claim 18, configured to send the information from the WTRU based on a request from a User Equipment (UE) application.

22. The WTRU of claim 18, wherein each of the at least two quality related parameter values includes at least one of a 5G QOS Identifier (5QI), a 5G System (5GS) Delay value, or a Packet Delay Budget (PDB) value.

23-32. (canceled)
